(19) United States
(12) Patent Application Publication
(10) Pub. No.: US 2021/0180157 A1
(43) Pub. Date: Jun. 17, 2021

(54) COPPER-BASED HARDFACING ALLOY

(71) Applicant: Oerlikon Metco (US) Inc., Westbury, NY (US)

(72) Inventors: Jonathon Bracci, Escondido, CA (US); Cameron Eibl, Encinitas, CA (US); Justin Lee Cheney, Encinitas, CA (US); Arkadi Zikin, Wohlen (CH); Jörg Spatzier, Ordof (CH)

(21) Appl. No.: 17/256,550

(22) PCT Filed: Jun. 27, 2019
(86) PCT No.: PCT/US2019/039463

§ 371 Date: Dec. 28, 2020

Related U.S. Application Data
(60) Provisional application No. 62/692,576, filed on Jun. 29, 2018.

(51) Int. Cl. C22C 9/06; B23K 26/00; B23K 35/02; B23K 35/30

(52) U.S. Cl. CPC C22C 9/06; B23K 26/0006; B23K 2103/12; B23K 35/302; B23K 35/0266

(57) ABSTRACT

Disclosed herein are embodiments of copper-based alloys. The alloys can comprise hard phases of silicides and can be free or substantially free of Co, Mn, Mo, Ta, V, and W. The copper-based alloys can be used as feedstock for PTA and laser cladding hardfacing processes, and can be manufactured into cored wires used to form hardfacing layers.

INCORPORATION BY REFERENCE TO ANY PRIORITY APPLICATIONS

This application claims from the benefit of U.S. App. No. 62/692,576, filed Jun. 29, 2018, and entitled “COPPER-BASED HARDFACING ALLOY”, the entirety of which is incorporated by reference herein.

### BACKGROUND

### Field

Embodiments of the disclosure generally relate to copper-based alloys with silicides free or substantially free of Co, Mn, Mo, Ta, V, and/or W.

### Description of the Related Art

There currently exists copper-based hardfacing materials designed to be abrasion and crack resistant. These alloys typically form complex silicide phases within a copper matrix. Copper-based alloys provide excellent thermal conductivity, corrosion resistance, high temperature properties, and have been found to be most suitable for cladding onto aluminum-based substrates. The addition of hard silicide phases into copper alloys have been utilized as a means of increasing the alloy's wear resistance, and typically are based around the formation of silicides containing any combination of Co, Mn, Mo, Ta, V, and/or W.

### SUMMARY

Disclosed herein are embodiments of a welding feedstock comprising Cu, Fe: about 7.2 to about 19.2 wt. %, Mn or Ni: about 4 to about 20.4 wt. %, and Si: about 2.4 to about 7.2 wt. %, wherein the welding feedstock comprises a total of about 2 wt. % or less of Co, Mn, Mo, Ta, V, and W.

In some embodiments, the welding feedstock can further comprise Nb: about 0.8 to about 1.2 wt. %, and C: about 0.08 to about 0.12 wt. %. In some embodiments, the welding feedstock can comprise Nb: about 0.9 to about 1.1 wt. %, and C: about 0.9 to about 0.11 wt. %. In some embodiments, the feedstock can comprise Fe: about 7.2 to about 10.8 wt. %, Mn or Ni: about 13.6 to about 20.4 wt. %, and Si: about 2.4 to about 3.6. In some embodiments, the feedstock can comprise Fe: about 8.1 to about 9.9 wt. %, Mn or Ni: about 15.3 to about 18.7 wt. %, and Si: about 2.7 to about 3.3 wt. %. In some embodiments, the feedstock can comprise Fe: about 7.2 to about 10.8 wt. %, Mn or Ni: about 4 to about 6 wt. %, and Si: about 3.2 to about 4.8 wt. %. In some embodiments, the feedstock can comprise Fe: about 8.1 to about 9.9 wt. %, Mn or Ni: about 4.5 to about 5.5 wt. %, and Si: about 3.6 to about 4.4 wt. %. In some embodiments, the feedstock can comprise Fe: about 12.8 to about 19.2 wt. %, Mn or Ni: about 11.2 to about 16.8 wt. %, Si: about 3.2 to about 4.8 wt. %, and B: about 0.8 to about 1.2 wt. %. In some embodiments, the feedstock can comprise Fe: about 14.4 to about 17.6 wt. %, Mn or Ni: about 12.6 to about 15.4 wt. %, Si: about 3.6 to about 4.4 wt. %, and B: about 0.9 to about 1.1 wt. %. In some embodiments, the feedstock can comprise Fe: about 11.2 to about 16.8 wt. %, Mn or Ni: about 10.8 to about 15.6 wt. %, and Si: about 4.8 to about 7.2 wt. %. In some embodiments, the feedstock can comprise Fe: about 12.6 to about 15.4 wt. %, Mn or Ni: about 12.6 to about 14.3 wt. %, and Si: about 5.4 to 6.6 wt. %.

In some embodiments, the feedstock can be configured to form a Cu-based matrix comprising at least about 85 wt. % Cu. In some embodiments, the welding feedstock can be substantially free of nickel. In some embodiments, the welding feedstock can be a powder. In some embodiments, the welding feedstock can be configured to be applied as a layer via a laser.

In some embodiments, the feedstock can be characterized by having a total hard phase fraction of silicides, carbides and borides at 1100K of at least 10 mole %, wherein the feedstock is configured to form two immiscible liquid phases during solidification and is configured to form a microstructure containing hard phases within a Cu-based matrix, and wherein a silicide phase formation temperature of the feedstock is between 1000K and 1600K. In some embodiments, the feedstock can be characterized by having a total hard phase fraction of silicides, carbides and borides at 1100K of at least 15 mole %, and wherein a silicide phase formation temperature of the alloy is between 1000K and 1400K. In some embodiments, the feedstock can be characterized by having a total hard phase fraction of silicides, carbides and borides at 1100K of at least 20 mole %, and wherein a silicide phase formation temperature of the feedstock is between 1000K and 1300K.

Also disclosed herein are embodiments of a hardfacing layer formed from the welding feedstock of embodiments of the disclosure.

In some embodiments, the hardfacing layer can comprise a Cu-based matrix comprising at least 85 wt. % Cu. In some embodiments, the hardfacing layer can comprise a Cu-based matrix comprising at least 90 wt. % Cu. In some embodiments, the hardfacing layer can comprise a Cu-based matrix comprising at least 95 wt. % Cu.

In some embodiments, the hardfacing layer can comprise a total volume fraction of silicides, carbides and borides of at least 10 volume %, wherein the hardness of the silicide phase is equal to or less than 1200 HV, and wherein the hardfacing layer contains a total of about 2 wt. % or less of Co, Mn, Mo, Ta, V, and W. In some embodiments, the hardfacing layer can comprise a total volume fraction of silicides, carbides and borides of at least 15 volume %, wherein the hardness of the silicide phase is equal to or less than 100 HV, and wherein the hardfacing layer contains a total of about 2 wt. % or less of Co, Mn, Mo, Ta, V, and W. In some embodiments, the hardfacing layer can comprise a total volume fraction of silicides, carbides and borides of at least 20 volume %, wherein the hardness of the silicide phase is equal to or less than 800 HV, and wherein the hardfacing layer contains a total of about 2 wt. % or less of Co, Mn, Mo, Ta, V, and W.

In some embodiments, the hardfacing layer can comprise an ASTM G77 volume loss of at most 1.0 mm³, 2 cracks or fewer per square inch when forming a hardfacing layer, and wherein the hardfacing layer contains a total of about 2 wt. % or less of Co, Mn, Mo, Ta, V and W. In some embodiments, the hardfacing layer can comprise an ASTM G77 volume loss of at most 0.9 mm³, 1 cracks or fewer per square inch when forming a hardfacing layer, and wherein the hardfacing layer contains a total of about 2 wt. % or less of Co, Mn, Mo, Ta, V and W. In some embodiments, the hardfacing layer can comprise an ASTM G77 volume loss of at most 0.8 mm³, 0 cracks or fewer per square inch when forming a hardfacing layer, and wherein the hardfacing layer contains a total of about 2 wt. % or less of Co, Mn, Mo, Ta, V and W.

A method of applying a hardfacing layer, the method comprising laser welding the welding feedstock of any of the disclosed embodiments, wherein the welding feedstock is a powder.

In some embodiments, an article of manufacture can comprise an alloy forming or configured to form a material comprising a Cu-based matrix comprising at least 85 weight % Cu and a total hard phase fraction of silicides, carbides and borides at 1100K of at least 10 mole %, wherein the alloy is configured to form two immiscible liquid phases during solidification and forms a microstructure containing hard phases within the Cu-based matrix, wherein a silicide phase formation temperature of the alloy is between 1000K and 1600K, and wherein the alloy contains a total of about 2 wt. % or less of Co, Mn, Mo, Ta, V, and W.

In some embodiments, the article of manufacture can comprise an alloy forming or configured to form a material comprising a Cu-based matrix comprising at least 90 weight % Cu and a total hard phase fraction of silicides, carbides and borides at 1100K of at least 15 mole %, wherein a silicide phase formation temperature of the alloy is between 1000K and 1400K. In some embodiments, the article of manufacture can comprise an alloy forming or configured to form a material comprising a Cu-based matrix comprising at least 95 weight % Cu and a total hard phase fraction of silicides, carbides and borides at 1100K of at least 20 mole %, wherein the silicide phase formation temperature of the alloy is between 1000K and 1300K.

In some embodiments, the alloy of the article of manufacture forms or is configured to form a material comprising Cu and in weight percent: C: about 0.1 to about 1.0; Cr: about 5 to about 20; Fe: about 1 to about 15; Nb: about 0 to about 5; Ni: about 5 to about 20; Si: about 2 to about 5; and Ti: about 0 to about 5.

In some embodiments, the alloy of the article of manufacture is in the form of a feedstock comprising Cu and in weight %: C: 0.1, Cr: 6.5, Fe: 9, Nb: 1, Ni: 17, Si: 3; C: 0.1, Cr: 7, Fe: 9, Nb: 1, Ni: 5, Si: 4; C: 0.6, Cr: 5, Fe: 5, Nb: 5, Ni: 5, Si: 4; C: 0.1 Fe: 18, Nb: 1. Ni:7, Si:6; or C: 0.1 Fe: 14, Nb: 1. Ni:13, Si:6.

Also disclosed herein are embodiments of a hardfacing layer formed from the article of manufacture. In some embodiments, the article is applied onto a cylinder head for an internal combustion engine to form the hardfacing layer.

In some embodiments, the alloy of the article of manufacture is in the form of a powder. In some embodiments, the alloy of the article of manufacture is in the form of a metal cored wire.

Also disclosed herein are embodiments of an article of manufacture comprising an alloy forming or configured to form a material comprising a Cu-based matrix comprising at least 85 weight % Cu and a total volume fraction of silicides, carbides and borides of at least 10 volume %, wherein the hardness of the silicide phase is equal to or less than 1200 HV, and wherein the alloy contains a total of about 2 wt. % or less of Co, Mn, Mo, Ta, V, and W.

In some embodiments, the article of manufacture can comprise an alloy forming or configured to form a material comprising a Cu-based matrix comprising at least 90 weight % Cu and a total hard phase fraction of silicides, carbides and borides of at least 15 volume % comprising a silicide phase and a carbide phase, wherein the hardness of the silicide phase is equal to or less than 1000 HV. In some embodiments, the article of manufacture can comprise an alloy forming or configured to form a material comprising a Cu-based matrix comprising at least 95 weight % Cu and a total hard phase fraction of silicides, carbides and borides of at least 20 volume %, wherein the hardness of the silicide phase is equal to or less than 800 HV.

Also disclosed herein are embodiments of an article of manufacture comprising an alloy forming or configured to form a material having an ASTM G77 volume loss of at most 1.0 mm³, 2 cracks or fewer per square inch when forming a hardfacing layer, and wherein the alloy contains a total of about 2 wt. % or less of Co, Mn, Mo, Ta, V and W.

In some embodiments, the article of manufacture can comprise an alloy forming or configured to form a material comprising an ASTM G77 volume loss of 0.9 mm³ or less and 1 crack or fewer per square inch when forming a hardfacing layer. In some embodiments, the article of manufacture can comprise an alloy forming or configured to forma a material comprising an ASTM G77 volume loss of 0.8 mm³ or less and 0 cracks per square inch when forming a hardfacing layer.

Also disclosed herein are methods of laser welding comprising cladding an aluminum substrate using a metal cored copper-based wire.

In some embodiments, the method can comprise wherein a short wavelength laser of blue or green light is utilized. In some embodiments, the method can comprise wherein automotive components are clad. In some embodiments, the method can comprise wherein engine block valves or cylinder heads are clad.

In some embodiments, the method can comprise wherein the wire comprises Cu and in weight % C: about 0.1 to about 1.0, Cr: about 0 to about 20, Fe: about 1 to about 25, Nb: about 0 to about 5, Ni: about 5 to about 25, Si: about 2 to about 5, and Ti: about 0 to about 5.

### BRIEF DESCRIPTION OF THE DRAWINGS

FIG. 1 illustrates a phase diagram of an embodiment of the disclosure of alloy X14 showing the total mole fraction of hard phases present at 1100K and the maximum phase mole fraction of the second liquid phase.

FIG. 2 illustrates a phase diagram of an embodiment of the disclosure of alloy X17 showing the formation temperature of the first silicide phase to form.

FIG. 3 shows an SEM image of an embodiment of the disclosure of alloy X14 with silicide particles and an FCC matrix phase.

### DETAILED DESCRIPTION

Embodiments of the present disclosure include, but are not limited to, hardfacing/hardbanding materials, alloys, or powder compositions used to make such hardfacing/hardbanding materials, methods of forming the hardfacing/hardbanding materials, and the components or substrates incorporating or protected by these hardfacing/hardbanding materials.

In some embodiments, copper-based alloys as described herein may serve as effective feedstock for the plasma transferred arc (PTA) and laser cladding hardfacing processes. Some embodiments include the manufacture of copper-based alloys into cored wires for hardfacing processes, and the welding methods of copper-based wires and powders using wire fed laser and short wave lasers. In some embodiments, the alloys disclosed herein can be powders. In some embodiments, they may be welding material, such as, for example, applied by a laser.

In certain applications it is desirable to form a crack free clad metal layer with high thermal conductivity and high abrasion resistance. Copper alloys have high thermal conductivity and are thus a good choice for applications requiring a high thermally conductive cladding. In addition, copper alloys form a face centered cubic (FCC) crystal structure which possesses good toughness and crack resistant properties. The design of hard phases such as silicides, aluminides, borides or carbides into the FCC copper matrix can be used to increase the abrasion resistance of the alloy. However, the formation of hard phases in the alloy will affect crack susceptibility and machinability. Therefore, the design of the hard phases is critical for producing a microstructure that is both abrasion resistance while maintaining a high degree of toughness and resistance to cracking.

Disclosed herein are copper alloys that have been developed with specific hard phase/phases that form in the alloy in order to provide an optimal balance of toughness, abrasion resistance, machinability, and alloy cost. By utilizing silicides free or substantially free of expensive elements such as Co, Mn, Mo, Ta, V, and/or W, the alloy's cost can be kept at a minimum. In addition, the hardness of these types of silicides containing Co, Mn, Mo, Ta, V, and/or W is relatively high, >900 HV. Furthermore, eliminating Co, Mn, Mo, Ta, V, and W from the alloy reduces the hardness of the silicide phase which improves the alloy's crack resistance and machinability.

Alloys which do not utilize Co are also desirable from an environmental health perspective. Co-bearing alloys produce harmful fumes during the welding process. Alloys which do not utilize Mo, Ta, V, and W are advantageous from a manufacturing cost perspective. Furthermore, elements Fe and Ni are significantly costly. Alloys which do not utilize Mn are advantageous from a manufacturing and processability perspective as Mn readily oxidizes, which increases manufacturing and welding process complexity. In the complex alloy space, it is not possible to simply remove an element or substitute one for the other and yield equivalent results.

In some embodiments, computational metallurgy is used to identify alloys which form two immiscible liquid phases during solidification to form a microstructure containing hard silicide phases in a FCC copper matrix. During solidification, one immiscible liquid phase rich in copper solidifies into the copper FCC matrix phase. The second immiscible liquid phase rich in all the other alloying elements solidifies to form the isolated hard silicide phase particles contained within the copper FCC matrix.

As disclosed herein, the term alloy can refer to the chemical composition forming the powder disclosed within, the powder itself, the feedstock itself, the wire, the wire including a powder, the composition of the metal component formed by the heating and/or deposition of the powder (for example hardbanding/hardfacing layer), or other methodology, and the metal component.

In some embodiments, alloys manufactured into a solid or cored wire (a sheath containing a powder) for welding or for use as a feedstock for another process may be described by specific chemistries herein. For example, the wires can be used for a thermal spray. Further, the compositions disclosed below can be from a single wire or a combination of multiple wires (such as 2, 3, 4, or 5 wires).

### Metal Alloy Composition

In some embodiments, alloys can be fully characterized by their compositional ranges. In some embodiments, alloys can be characterized by their thermodynamic criteria. In some embodiments, the alloys can be free or substantially free of Co, Mn, Mo, Ta, V, and/or W. The term “substantially free” may be understood to mean 2 wt. % (or about 2 wt. %) or less, 1 wt. % (or about 1 wt. %) or less, 0.5 wt. % (or about 0.5 wt. %) or less, 0.1 wt. % (or about 0.1 wt. %) or less, or 0.01 wt. % (or about 0.01 wt. %) or less of a specified element, or any range between any of these values. In some embodiments, alloys substantially free of Co, Mn, Mo, Ta, V, and W refers to there being 2 wt. % (or about 2 wt. %) or less, 1 wt. % (or about 1 wt. %) or less, 0.5 wt. % (or about 0.5 wt. %) or less, 0.1 wt. % (or about 0.1 wt. %) or less, or 0.01 wt. % (or about 0.01 wt. %) or less of all of those elements combined.

In some embodiments, the composition can comprise in weight percent the following elemental ranges:
Cu: balance;
B: 0 to 2 (or about 0 to about 2);
C: 0 to about 1.0 (or about 0 to about 1.0);
Cr: about 0 to about 12 (or about 0 to about 12);
Fe: about 1 to about 25 (or about 1 to about 25);
Nb: about 0 to about 5 (or about 0 to about 5);
Ni: about 5 to about 25 (or about 5 to about 25);
Si: about 2 to about 11 (or about 2 to about 11); and
Ti: about 0 to about 1 (or about 0 to about 1).

In some embodiments, the composition can comprise in weight percent the following elemental ranges:
Cu: Balance;
Cr: 5 to 12 (or about 5 to about 12);
Fe: 5 to 9 (or about 5 to about 9);
Ni: 5 to 17 (or about 5 to about 17);
Si: 3 to 4 (or about 3 to about 4); and
Ti: 0 to 1 (or about 0 to about 1).

In some embodiments, the composition can comprise in weight percent the following elemental ranges:
Cu: Balance;
C: 0.1 to 1.0 (or about 0.1 to about 1.0);
Cr: 5 to 20 (or about 5 to about 20);
Fe: 1 to 15 (or about 1 to about 15);
Nb: 0 to 5 (or about 0 to about 5);
Ni: 5 to 20 (or about 5 to about 20);
Si: 2 to 5 (or about 2 to about 5); and
Ti: 0 to 5 (or about 0 to about 5).

In some embodiments, the composition can be free or substantially free of chromium. In some embodiments, the composition can comprise in weight percent the following elemental ranges:
Cu: Balance;
Fe: 15 to 25 (or about 15 to about 25);
Ni: 5 to 20 (or about 5 to about 20); and
Si: 4 to 8 (or about 4 to about 8).

In some embodiments, the composition can be free or substantially free of nickel. In some embodiments, the composition can comprise in weight percent the following elemental ranges:
Cu: Balance;
Fe: 15 to 25 (or about 15 to about 25); and
Si: 4 to 8 (or about 4 to about 8).

Table I lists a number of experimental alloys, with their compositions listed in weight percent and the balance Cu, produced in the form of small scale ingots.

TABLE I
List of Nominal Experimental Alloy Compositions,
Balance Copper + Minor Impurities

| Alloy | B | C | Cr | Fe | Nb | Ni | Si |
|---|---|---|---|---|---|---|---|
| P92-X14 | | 0.1 | 6.5 | 9 | 1 | 17 | 3 |
| P92-X16 | | 0.1 | 7 | 9 | 1 | 10 | 4 |
| P92-X17 | | 0.1 | 7 | 9 | 1 | 5 | 4 |
| P92-X18 | | 0.1 | 12 | 9 | 1 | 14 | 4 |
| P92-X19 | | 0.1 | 12 | 9 | | 14 | 4 |
| P92-X20 | | 0.2 | 5 | 5 | 3 | 10 | 4 |
| P92-X21 | | 0.6 | 5 | 5 | 5 | 5 | 4 |
| P92-X23 | | 0.1 | | 12 | 1 | 11 | 11 |
| P92-X24 | | 0.1 | | | 1 | 24 | 4 |
| P92-X25 | | 0.1 | | 18 | 1 | 7 | 6 |
| P92-X26 | | 0.1 | | 21 | 1 | | 6 |
| P92-X27 | 2 | 0.1 | | 14 | 1 | 14 | 3 |
| P92-X28 | 1 | | | 16 | | 14 | 4 |
| P92-X29 | | 0.1 | | 14 | 1 | 13 | 6 |

In some embodiments, the composition can comprise Nb and/or C. In some embodiments, Nb and/or C may encourage a fine scale microstructure. In some embodiments, the composition can further comprise in weight percent the following elemental ranges:
Nb: 0.1-5 (or about 0.1-about 5); and
C: 0.01-0.6 (or about 0.01 to about 0.6).

In some embodiments, the composition can further comprise in weight percent the following elemental ranges:
Nb: 0.1-2 (or about 0.1-about 2); and
C: 0.01-0.2 (or about 0.01-about 0.2).

In some embodiments, the composition can comprise a minimum copper content. In some embodiments, the composition can comprise copper in at least 55 wt. %, at least 60 wt. %, at least 65 wt. %, at least 68 wt. %, at least 70 wt. %, at least 75 wt. % or at least 80 wt. % (or at least about 55 wt. %, at least about 60 wt. %, at least about 65 wt. %, at least about 68 wt. %, at least about 70 wt. %, at least about 75 wt. % or at least about 80 wt. %) or any range between any of these values.

In some embodiments, the composition can comprise boron. In some embodiments, boron is used as an alloying addition. In some embodiments, the composition can have up to 2 wt. % (or about 2 wt. %) boron. In some embodiments, the composition can have 1 wt. % (or about 1 wt. %) boron. In some embodiments, the composition can be boron free.

In some embodiments, the composition can comprise copper and, in weight percent the following elemental ranges:
Fe: 7.2 to 19.2 (or about 7.2 to about 19.2);
Mn or Ni: 4 to 20.4 (or about 4 to about 20.4); and
Si: 2.4 to 7.2 (or about 2.4 to about 7.2).

In some embodiments, the composition can comprise copper and, in weight percent the following elemental ranges:
Fe: 7.2-10.8 (or about 7.2-about 10.8);
Mn or Ni: 13.6-20.4 (or about 13.6-about 20.4); and
Si: 2.4-3.6 (or about 2.4-about 3.6).

In some embodiments, the composition can comprise copper and, in weight percent the following elemental ranges:
Fe: 8.1-9.9 (or about 8.1-about 9.9);
Mn or Ni: 15.3-18.7 (or about 15.3-about 18.7); and
Si: 2.7-3.3 (or about 2.7-about 3.3).

In some embodiments, the composition can comprise copper and, in weight percent the following elemental ranges:
Fe: 7.2-10.8 (or about 7.2-about 10.8);
Mn or Ni: 4-6 (or about 4-about 6); and
Si: 3.2-4.8 (or about 3.2-about 4.8).

In some embodiments, the composition can comprise copper and, in weight percent the following elemental ranges:
Fe: 8.1-9.9 (or about 8.1-about 9.9);
Mn or Ni: 4.5-5.5 (or about 4.5 -about 5.5); and
Si: 3.6-4.4 (or about 3.6-about 4.4).

In some embodiments, the composition can comprise copper and, in weight percent the following elemental ranges:
Fe: 12.8-19.2 (or about 12.8-about 19.2);
Mn or Ni: 11.2-16.8 (or about 11.2-about 16.8);
Si: 3.2-4.8 (or about 3.2-about 4.8); and
B: 0.8-1.2 (or about 0.8-about 1.2).

In some embodiments, the composition can comprise copper and, in weight percent the following elemental ranges:
Fe: 14.4-17.6 (or about 14.4-about 17.6);
Mn or Ni: 12.6-15.4 (or about 12.6-about 15.4);
Si: 3.6-4.4 (or about 3.6-about 4.4); and
B: 0.9-1.1 (or about 0.9-about 1.1).

In some embodiments, the composition can comprise copper and, in weight percent the following elemental ranges:
Fe: 11.2-16.8 (or about 11.2-about 16.8);
Mn or Ni: 10.4-15.6 (or about 10.4-about 15.6); and
Si: 4.8-7.2 (or about 4.8-about 7.2).

In some embodiments, the composition can comprise copper and, in weight percent the following elemental ranges:
Fe: 12.6-15.4 (or about 12.6-about 15.4);
Mn or Ni: 12.6-14.3 (or about 12.6-about 14.3); and
Si: 5.4-6.6 (or about 5.4-about 6.6).

In some embodiments, any of the above compositions can further comprise in weight percent the following elemental ranges:
Nb: 0.8-1.2 (or about 0.8-about 1.2); and
C: 0.08-0.12 (or about 0.08-about 0.12).

In some embodiments, any of the above compositions can further comprise in weight percent the following elemental ranges:
Nb: 0.9-1.1 (or about 0.9-about 1.1); and
C: 0.09-0.11 (or about 0.09-about 0.11).

In some embodiments, the disclosed compositions can be the wire/powder, the coating or other metallic component, or both.

The disclosed alloys can incorporate the above elemental constituents to a total of 100 wt. %. In some embodiments, the alloy may include, may be limited to, or may consist essentially of the above named elements. In some embodiments, the alloy may include 2 wt. % (or about 2 wt. %) or less, 1 wt. % (or about 1 wt. %) or less, 0.5 wt. % (or about 0.5 wt. %) or less, 0.1 wt. % (or about 0.1 wt. %) or less or 0.01 wt. % (or about 0.01 wt. %) or less of impurities, or any range between any of these values. Impurities may be understood as elements or compositions that may be included in the alloys due to inclusion in the feedstock components, through introduction in the manufacturing process. In some embodiments, an impurity may be Co, Mn, Mo, Ta, V, and/or W.

Further, the Cu content identified in all of the compositions described in the above paragraphs may be the balance of the composition as indicated above, or alternatively, where Cu is provided as the balance, the balance of the composition may comprise Cu and other elements. In some embodiments, the balance may consist essentially of Cu and may include incidental impurities.

### Thermodynamic Criteria

In some embodiments, alloys can be characterized by their equilibrium thermodynamic criteria. In some embodiments, the alloys can be characterized as meeting some of the described thermodynamic criteria. In some embodiments, the alloys can be characterized as meeting all of the described thermodynamic criteria.

A first thermodynamic criterion pertains to the matrix chemistry of the alloy, and may be used to quantify the alloy's thermal conductivity. This criterion characterizes the copper composition in the FCC copper rich matrix phase at 1200K. In some embodiments, the higher the copper content is in the matrix phase the higher the alloy's thermal conductivity will be.

In some embodiments, the copper content in the FCC matrix at 1200K is at least 60 weight %, at least 70 weight %, at least 75 weight %, at least 80 weight %, at least 85 weight %, at least 90 weight %, at least 95 weight % or at least 98 weight %, (or at least about 60 weight %, at least about 70 weight %, at least about 75 weight %, at least about 80 weight %, at least about 85 weight %, at least about 90 weight %, at least about 95 weight % or at least about 98 weight %) or any range between any of these values. The copper content in the FCC matrix may not closely relate to the copper content in the alloy's bulk composition. In some embodiments, the matrix may contain from 30-50% (or about 30-about 50%) more copper at 1200K as compared to the copper in the alloy composition.

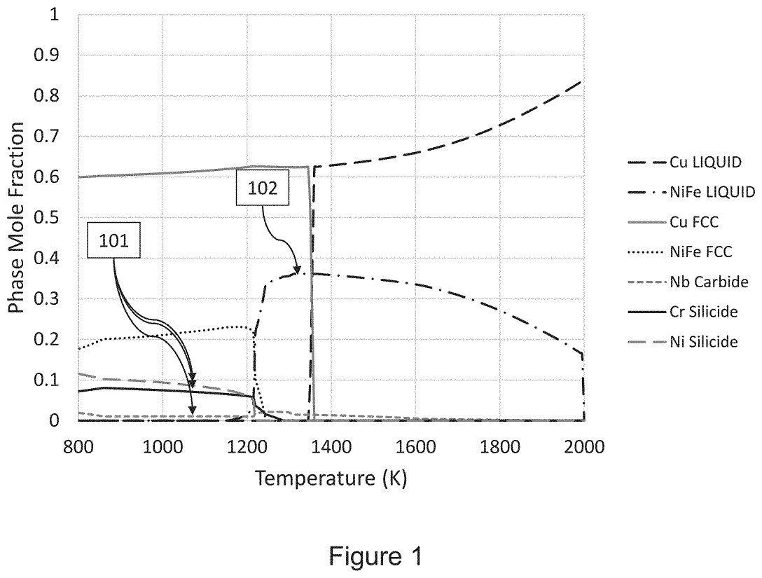

A second thermodynamic criterion pertains to the alloy's abrasion resistance, and the second thermodynamic criterion is defined as the total mole fraction of hard phases present at 1100K, shown at 101 in FIG. 1. In some embodiments, the total mole fraction of hard phases can comprise silicides, carbides and/or borides. In some embodiments, controlling the phase fraction of hard silicides can be an important design aspect of alloys, as optimal phase fraction of silicide may aid in obtaining an alloy with an optimal balance of wear resistance, crack resistance and machinability.

In some embodiments, the total hard phase fraction at 1100K is at least 5 mole %, at least 10 mole %, at least 15 mole %, at least 20 mole %, at least 25 mole % or at least 30 mole %, (or at least about 5 mole %, at least about 10 mole %, at least about 15 mole %, at least about 20 mole %, at least about 25 mole % or at least about 30 mole %) or any range between any of these values.

A third thermodynamic criterion pertains to the alloy's crack resistance, and the third thermodynamic criterion is defined as the maximum phase mole fraction of the second liquid phase, shown at 102 in FIG. 1. During a welding process, the alloy may separate into two liquids. One liquid can form a ductile copper phase. The other liquid can form a hard but brittle phase, likely due to the presence of silicides and/or borides. Thus, the higher phase fraction of the second liquid phase will result in a more brittle phase with an increased tendency to crack.

In some embodiments, this third criterion can be used in conjunction with the second thermodynamic criterion (i.e. total hard phase at 1100K) to predict abrasion resistance and/or hard phase morphology. It was determined that reducing the maximum mole fraction of the second liquid phase produces silicide precipitates that are finer and more evenly dispersed throughout the microstructure. In some embodiment, controlling the hard phase morphology and mole fraction can be an important design aspect for producing a microstructure that is both crack resistant and abrasion resistant.

In some embodiments, the maximum second liquid phase fraction is at most 55 mole %, at most 50 mole %, at most 45 mole %, at most 35 mole %, at most 25 mole %, at most 20 mole %, at most 15 mole % or at most 10 mole % (or at most about 55 mole %, at most about 50 mole %, at most about 45 mole %, at most about 35 mole %, at most about 25 mole %, at most about 20 mole %, at most about 15 mole % or at most about 10 mole %), or any range between any of these values.

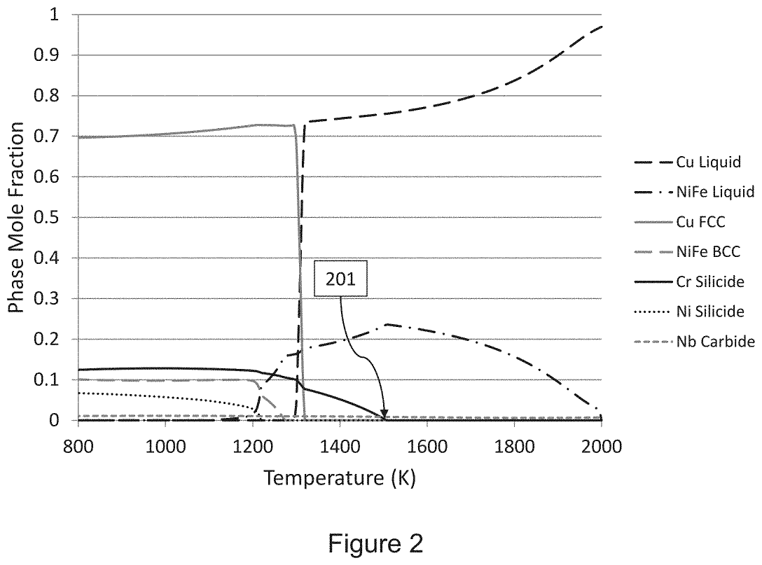

A fourth thermodynamic criterion pertains to the hardness of the silicide precipitates. This criterion characterizes the formation temperature of the first silicide phase to form, shown at 201 in FIG. 2. It was determined that as the formation temperature of the silicide phase increases, the silicides become more enriched in the silicide forming elements and form a harder silicide. In some embodiments, controlling the hardness of the silicide phase can be an important design aspect of alloys, as the hardness of the silicide phase affects the wear resistance, crack resistance and machinability of the alloy. In some embodiments, an alloy comprising silicide with a high level of hardness may result in adequate wear resistance, but poor crack resistance and machinability. In some embodiments, an alloy comprising silicide with a low level of hardness may result in poor wear resistance, but adequate crack resistance and machinability.

In some embodiments, the silicide formation temperature is about between 900K and 1700K, between 1000K and 1600K, between 1000K and 1400K, between 1000K and 1300K, between 1100K and 1500K or between 1200K and 1400K (or between about 900K and about 1700K, between about 1000K and about 1600K, between about 1000K and about 1400K, between about 1000K and about 1300K, between about 1100K and about 1500K or between about 1200K and about 1400K), or any range between any of these values.

Table II lists a number of the experimental alloys within the four thermodynamic criteria, and displays the alloys' calculated thermodynamic results.

TABLE II
List of Calculated Thermodynamic Criteria for Experimental Alloys,
*may include boride formation temperature, whichever forms first.

| | Cu in Matrix | Total Hard | Max Second | Silicide |
|---|---|---|---|---|
| | at 1200K | at 1100K | Liquid | Formation |
| Alloy | (weight %) | (mole %) | (mole %) | Temp. (K) |
| P92-X14 | 93.9 | 16.3 | 36.2 | 1285 |
| P92-X16 | 95.5 | 22.4 | 30.4 | 1430 |
| P92-X17 | 95.8 | 18.6 | 23.6 | 1505 |
| P92-X18 | 94.2 | 25.6 | 40.9 | 1455 |
| P92-X19 | 94.3 | 22.9 | 42.1 | 1460 |
| P92-X20 | 95.8 | 19.8 | 22.5 | 1470 |
| P92-X21 | 96.0 | 21.9 | 14.4 | 1540 |
| P92-X23 | 95.4 | 39.3 | 33.2 | 1400 |
| P92-X24 | 94.2 | 30.2 | 26.3 | 1400 |
| P92-X25 | 95.9 | 9.7 | 31.7 | 1300 |
| P92-X26 | 96.6 | 7.9 | 26.8 | 1250 |
| P92-X27 | 95.5 | 41 | 41.4 | 1550* |
| P92-X28 | 95.8 | 32.7 | 39.5 | 1300* |

### Microstructural Criteria

In some embodiments, alloys can be described by their microstructural criterion. In some embodiments, the alloys can be characterized as meeting some of the described microstructural criteria. In some embodiments, the alloys can be characterized as meeting all of the described microstructural criteria.

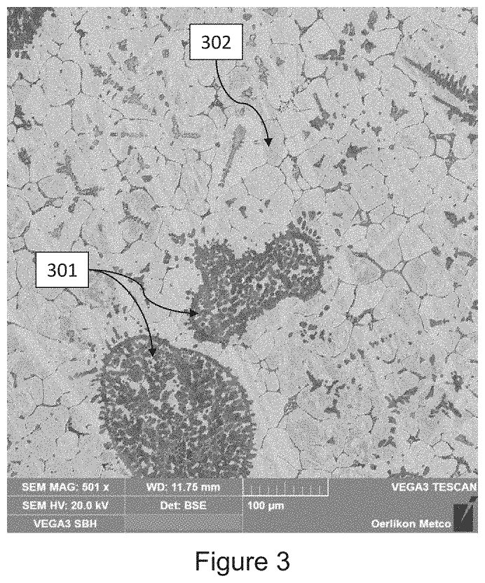

A first microstructural criterion pertains to the total measured volume fraction of hard particles and/or hard phases. In some embodiments, this first microstructural criterion pertains to the total measured volume of hard particles and/or hard phases that are silicides. FIG. 3 shows silicide particles 301 according to one embodiment. In some embodiments, the total measured volume fraction of hard particles and/or hard phases can comprise silicides, carbides and/or borides.

In some embodiments, the total measured volume fraction of hard particles and/or hard phases is at least 5 volume %, at least 8 volume %, at least 10 volume %, at least 15 volume %, at least 20 volume %, at least 25 volume % or at least 30 volume % (or at least about 5 volume %, at least about 8 volume %, at least about 10 volume %, at least about 15 volume %, at least about 20 volume %, at least about 25 volume % or at least about 30 volume %), or any range between any of these values.

In some embodiments, chromium silicides form as the hard phase. In some embodiments, nickel silicides form as the hard phase. In some embodiments, iron silicides form as the hard phase. In some embodiments, nickel borides form as the hard phase. In some embodiments, iron borides form as the hard phase. In some embodiments, the hard phase may be a combination of two or more of chromium silicides, nickel silicides, iron silicides, nickel borides, and iron borides. In some embodiments, the hard phase may be a combination of two or more of nickel silicides, iron silicides, nickel borides, and iron borides.

A second microstructural criterion pertains to the thermal conductivity of the alloy. Copper is amongst one of the highest thermally conductive metals. Therefore, in some embodiments, maximizing the copper balance in the FCC matrix phase of the alloy may be advantageous for maximizing thermal conductivity. FIG. 3 shows the FCC matrix phase 302. Energy dispersive spectroscopy (EDS) is used to measure the weight % copper content in the alloy's matrix phase.

In some embodiments, the total copper content in the matrix is at least 70 weight %, at least 75 weight %, at least 80 weight %, at least 85 weight %, at least 90 weight %, at least 95 weight % or at least 97 weight % (or at least about 70 weight %, at least about 75 weight %, at least about 80 weight %, at least about 85 weight %, at least about 90 weight %, at least about 95 weight % or at least about 97 weight %), or any range between any of these values.

In some embodiments, the total copper in the alloy as a whole (e.g., not just the matrix) is maximized to increase the thermal conductivity of the alloy. In some embodiments, the minimum copper content is at least 55 wt. %, at least 60 wt. %, at least 65 wt. %, at least 68 wt. %, at least 70 wt. %, at least 75 wt. % or at least 80 wt. % (or at least about 55 wt. %, at least about 60 wt. %, at least about 65 wt. %, at least about 68 wt. %, at least about 70 wt. %, at least about 75 wt. % or at least about 80 wt. %), or any range between any of these values.

A third microstructural criterion pertains the hardness of the silicide phase. In some embodiments, controlling the hardness of the silicide can be an important design aspect for creating an optimized balance of wear resistance, crack resistance and machinability. The hardness of the silicide can increase with the formation temperature of the silicide. In some embodiments, silicide phases that are too hard may result in the alloy having greater crack susceptibility and poor machinability. Hardness of the silicide phases is measured using Vickers microhardness with a 50 grams force load.

In some embodiments, the hardness of the silicide is at most 1600 HV, at most 1400 HV, at most 1200 HV, at most 800 HV, at most 400 HV, at most 300 HV or at most 250 HV (at most about 1600 HV, at most about 1400 HV, at most about 1200 HV, at most about 800 HV, at most about 400 HV, at most about 300 HV or at most about 250 HV), or any range between any of these values. In some embodiments, the hardness of the silicide is 150 HV (or about 150 HV) or greater.

A fourth microstructural criterion pertains to the microstructure of precipitated hard phases. In some embodiments, morphology, size and distribution of precipitated hard phases may have a significant influence on thermo-physical and mechanical properties. In some embodiments, the fine grained precipitation of hard phases and their homogeneously distribution may be characteristic of laser-processed materials due to rapid undercooling. Thus, it can be advantageous to have silicide phases that are generally smaller in size.

In some embodiments, all silicides in the alloy can have a diameter of 200 microns (or about 200 microns) or less. In some embodiments, all silicides in the alloy can have a diameter of 150 microns (or about 150 microns) or less. In some embodiments, all silicides in the alloy can have a diameter of 100 microns (or about 100 microns) or less.

Table III lists a number of experimentally measured microstructural criteria results for alloys.

TABLE III
List of Experimentally Measured Microstructural
Criteria for Experimental Alloys

| | Energy | | |
|---|---|---|---|
| | Dispersive | | |
| | Spectroscopy | Bulk | Silicide |
| | Cu in Matrix | Hardness | Hardness |
| Alloy | (weight %) | (HV_{0.05}) | (HV_{0.05}) |
| P92-X14 | 87.6 | 186 | 278 |
| P92-X16 | 90.2 | 207 | 835 |
| P92-X17 | 93.0 | 191 | 1114 |
| P92-X18 | 86.3 | 200 | 1070 |
| P92-X19 | 89.1 | 200 | 1211 |
| P92-X20 | 89.9 | 245 | — |
| P92-X21 | 92.9 | 270 | — |
| P92-X25 | 92.4 | 195 | 642 |
| P92-X26 | 94.5 | 168 | 655 |

### Performance Criteria

In some embodiments, alloys can have a number of desirable performance characteristics. In some embodiments, it may be advantageous for alloys to have one or more of 1) a high resistance to metal to metal wear, 2) minimal to no cracks when welded via a laser cladding process, 3) easily machinable, and/or 4) a high thermal conductivity.

The metal to metal sliding wear resistance can be quantified using the ASTM G77 test. In some embodiments, a hardfacing layer can have an ASTM G77 volume loss of at most 1.4 mm³, at most 1.2 mm³, at most 1.0 mm³, at most 0.8 mm³, at most 0.6 mm³, at most 0.5 mm³ or at most 0.4 mm³ (or at most about 1.4 mm³, at most about 1.2 mm³, at most about 1.0 mm³, at most about 0.8 mm³, at most about 0.6 mm³, at most about 0.5 mm³ or at most about 0.4 mm³), or any range between any of these values.

In some embodiments, the hardfacing layer can exhibit 5 cracks per square inch of coating, 4 cracks per square inch of coating, 3 cracks per square inch of coating, 2 cracks per square inch of coating, 1 crack per square inch of coating, 0 cracks per square inch of coating. The square inch can be selected randomly.

An alloy's bulk hardness may be used as an indication of machinability. The lower the bulk the more machinable the alloy will be. In some embodiments, the bulk hardness can be at most 400 HV, at most 350 HV, at most 300 HV, at most 250 HV, at most 200 HV, at most 150 HV or at most 100 HV (or at most about 400 HV, at most about 350 HV, at most about 300 HV, at most about 250 HV, at most about 200 HV, at most about 150 HV or at most about 100 HV), or any range between any of these values. In some embodiments, the alloy can have a minimum bulk hardness of 100 HV (or about 100 HV).

### Article of Manufacture & Welding Process Concepts

In some embodiments, a novel process for laser cladding aluminum substrates is disclosed. In some embodiments, a cored wire is utilized. Typically, the hardfacing or cladding of aluminum substrates is accomplished using a powder feedstock. Utilization of a wire may be advantageous as wire enables higher productivity in both the cladding process and in feedstock manufacture. In some embodiments, the manufacture of a Cu-based metal cored wire is disclosed. In some embodiments, any one of the compositions described in Table I may be selected to manufacture a metal cored wire.

In some embodiments, the manufactured wire may be used in a welding process. In some embodiments, the wire may be used in a laser welding process. In some embodiments, a short wavelength laser may be used. In some embodiments, a blue wavelength laser is used. In some embodiments, blue wavelength lasers may output light at 400 nm, 425 nm, 450 nm, 475 nm or 500 nm, or at any range between any of these values. In some embodiments, a green wavelength laser is used. In some embodiments, green wavelength lasers may output light at 500 nm, 515 nm, 520 nm, 545 nm or 570 nm, or at any range between any of these values. In some embodiments, the wire welding process may be used in the cladding of automotive applications. In some embodiments, the wire welding process may be used to clad aluminum engine block valves or cylinder heads. In some embodiments, the wire welding process may be used to clad an aluminum substrate.

In some embodiments, a Cu-based powder is used in a short wavelength laser welding process. In some embodiments, a blue laser or green wavelength laser is used. In some embodiments, any one of the compositions described in Table I may be used in the short wavelength laser cladding process.

### EXAMPLES

### Example 1

Example 1 demonstrates how the formation temperature of the silicide phase may be used as an indicator of silicide hardness. Table IV provides a list of a number of experimentally fabricated alloys and their respective measured silicide chemistries, harnesses and calculated formation temperatures. Note that as the calculated silicide formation temperature increases there is a corresponding increase in silicide hardness. This is a direct result of the silicide composition increasing in the silicide forming elements, Cr and Si, which causes the increase in hardness.

TABLE IV
List of Experimental Alloys Comparing Silicide
Chemistry, Hardness and Formation Temperature

| | EDS Cr Content | EDS Si Content | Silicide | Silicide |
|---|---|---|---|---|
| | in Silicide | in Silicide | Hardness | Formation |
| Alloy | (weight %) | (weight %) | (HV_{0.05}) | Temp. (K) |
| P92-X14 | 20.5 | 5.3 | 278 | 1285 |
| P92-X16 | 28.1 | 10.4 | 835 | 1430 |
| P92-X17 | 40.8 | 9.3 | 1114 | 1505 |
| P92-X18 | 49.1 | 6.7 | 1070 | 1455 |
| P92-X19 | 47.6 | 7.8 | 1211 | 1460 |
| P92-X20 | 46.6 | 9.3 | — | 1470 |
| P92-X21 | 70.4 | 14.2 | — | 1540 |

### Example 2

Each copper-based hardfacing alloy was laser clad onto a 0.5 in thick aluminum plate for experimental analysis. The following test were performed on the laser clad overlays: microhardness, density, modulus of elasticity, thermal conductivity, and ASTM G133 reciprocating sliding wear test.

Table V lists the copper alloys that were gas atomized, laser clad and characterized in this investigation. CuLS70 is an alloy utilized by Toyota to clad their engine valves.

TABLE V
List of Cu-Based Hardfacing Alloys Laser Clad and Analyzed

| Alloy | B | C | Cr | Cu | Fe | Mo | Nb | Ni | Si | PSD |
|---|---|---|---|---|---|---|---|---|---|---|
| CuLS70 | | 0.05-0.15 | | Bal. | 8.55-9.55 | 6.41-6.71 | 0.5-1.5 | 16.8-17.8 | 2.66-2.96 | −180 + 45 μm |
| X14 | | 0.1 | 6.5 | 63.4 | 9 | | 1 | 17 | 3 | −150 + 45 μm |
| X17 | | 0.1 | 7 | 73.9 | 9 | | 1 | 5 | 4 | −150 + 45 μm |
| X28 | 1 | | | 65 | 16 | | | 14 | 4 | −150 + 45 μm |
| X29 | | 0.1 | | 65.9 | 14 | | 1 | 13 | 6 | −150 + 45 μm |

Table VI lists the result for microhardness, modulus of elasticity and density for each overlay. In some applications it is advantageous for the materials to have a low hardness for purposes of quicker machining in application. In some embodiments, the microhardness is 250 HV_{0.3} or below. In other applications, for purposes of a maximizing the wear resistance of the alloy it is useful to maximize the hardness. In such applications, the microhardness is 350 HV_{0.3} or greater. In some embodiments, the elastic modulus of the material can be less than 160 GPa (or about 160 GPa). In some embodiments, the elastic modulus of the material can be less than 150 GPa (or about 150 GPa). In some embodiments, the density of the alloy can be less than 8 (or less than about 8) g/cm³.

TABLE VI
Microhardness, Elastic Modulus and Density Results

| | Microhardness | Elastic Modulus | Density |
|---|---|---|---|
| Overlay | (HV_{0.3}) | (GPa) | (g/cm³) |
| CuLS70 | 294 | 162 | 8.26 |
| X14 | 263 | 158 | 7.89 |
| X17 | 235 | — | 7.93 |
| X28 | 402 | 155 | 7.74 |
| X29 | 330 | 124 | 7.89 |

Table VII list the thermal conductivity testing results. Thermal conductivity was measured using laser flash analysis at four different temperatures: room temperature, 150, 250, and 350 degrees Celsius. In some applications it is advantageous to have an elevated thermal conductivity. In some embodiments, the thermal conductivity of the deposited alloy is >20 W/m K (or >about 20 W/m K) at 150° C. In some embodiments, the thermal conductivity of the deposited alloy is >30 W/m K (or >about 30 W/m K) at 150° C. In some embodiments, the thermal conductivity of the deposited alloy is >40 W/m K (or >about 40 W/m K) at 150° C.

TABLE VII
Thermal Conductivity Results

| Temperature | Thermal Conductivity (W/m-K) | | | | |
|---|---|---|---|---|---|
| (° C.) | CuLS70 | X17 | X28 | X14 | X29 |
| 25 | 21.2 | 29.5 | 16.4 | 33.2 | 16.6 |
| 150 | 14.2 | 36.2 | 15.3 | 36.9 | 31.3 |
| 250 | 10.7 | 39.4 | 14.7 | 42.2 | 31.7 |
| 350 | 8.6 | 46.5 | 18.5 | 48.9 | 36.5 |

Table VIII lists the result for the ASTM G133 reciprocating sliding wear test. This test uses a pin with a hemispherical head that is pressed against the hardfacing overlay with a certain load and reciprocated across the surface of the sample 5,400 times. The volume loss from the pin and from the hardfacing overlay is then measured. For this test two different types of pins where tested. One set of pins was fabricated from austenitic steel and the second from martensitic steel. The pin steels are representative of the type of steel used in engine valves. In addition, the test was performed at an elevated temperature of 120° C. It is advantageous for both the pin and overlay wear volume to be minimized in application.

In some embodiments, the wear volume of a martensitic pin run against the alloy is less than 0.006 mm³ (or less than about 0.006 mm³). In some embodiments, the wear volume of a martensitic pin run against the alloy is less than 0.005 mm³ (or less than about 0.005 mm³). In some embodiments, the wear volume of the overlay run against a martensitic pin is less than 0.02 mm³ (or less than about 0.02 mm³). In some embodiments, the wear volume of the overlay run against a martensitic pin is less than 0.015 mm³ (or less than about 0.015 mm³). In some embodiments, the wear volume of an austenitic pin run against the alloy is less than 0.002 mm³ (or less than about 0.002 mm³), In some embodiments, the wear volume of an austenitic pin run against the alloy is less than 0.001 mm³ (or less than about 0.001 mm³). In some embodiments, the wear volume of the overlay run against an austenitic pin is less than 0.02 mm³ (or less than about 0.02 mm³). In some embodiments, the wear volume of the overlay run against an austenitic pin is less than 0.01 mm³ (or less than about 0.01 mm³).

TABLE VIII
ASTM G133 Reciprocating Sliding Wear Results

| | Pin | Pin Wear Scar | Overlay Wear Scar |
|---|---|---|---|
| Overlay | Material | Volume Loss (mm³) | Volume Loss (mm³) |
| CuLS70 | Austenite | 0.0026 | 0.0401 |
| | Martensite | 0.0081 | 0.0317 |
| X14 | Austenite | 0.0134 | 0.2111 |
| | Martensite | 0.0090 | 0.0251 |
| X17 | Austenite | 0.0008 | 0.0093 |
| | Martensite | 0.0090 | 0.0120 |
| X28 | Austenite | 0.0030 | 0.0271 |
| | Martensite | 0.0045 | 0.0409 |
| X29 | Austenite | 0.0020 | 0.0232 |
| | Martensite | 0.0081 | 0.0249 |

### Applications

The alloys described in this disclosure can be used in a variety of applications and industries. Some non-limiting examples of applications of use include:

Surface Mining applications include the following components and coatings for the following components: Wear resistant sleeves and/or wear resistant hardfacing for slurry pipelines, mud pump components including pump housing or impeller or hardfacing for mud pump components, ore feed chute components including chute blocks or hardfacing of chute blocks, separation screens including but not limited to rotary breaker screens, banana screens, and shaker screens, liners for autogenous grinding mills and semi-autogenous grinding mills, ground engaging tools and hardfacing for ground engaging tools, wear plate for buckets and dump truck liners, heel blocks and hardfacing for heel blocks on mining shovels, grader blades and hardfacing for grader blades, stacker reclaimers, sizer crushers, general wear packages for mining components and other comminution components.

From the foregoing description, it will be appreciated that inventive copper-based hardfacing alloys and methods of use are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount. Additionally, all values of tables within the disclosure are understood to either be the stated values or, alternatively, about the stated value.

The disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A welding feedstock comprising:
Cu;
Fe: about 7.2 to about 19.2 wt. %;
Mn or Ni: about 4 to about 20.4 wt. %; and
Si: about 2.4 to about 7.2 wt. %;
wherein the welding feedstock comprises a total of about 2 wt. % or less of Co, Mn, Mo, Ta, V, and W.

2. The welding feedstock of claim 1, further comprising:
Nb: about 0.8 to about 1.2 wt. %; and
C: about 0.08 to about 0.12 wt. %.

3. The welding feedstock of claim 2, comprising:
Nb: about 0.9 to about 1.1 wt. %; and
C: about 0.9 to about 0.11 wt. %.

4. The welding feedstock of claim 1, comprising:
Fe: about 7.2 to about 10.8 wt. %;
Mn or Ni: about 13.6 to about 20.4 wt. %; and
Si: about 2.4 to about 3.6.

5. The welding feedstock of claim 4, comprising:
Fe: about 8.1 to about 9.9 wt. %;
Mn or Ni: about 15.3 to about 18.7 wt. %; and
Si: about 2.7 to about 3.3 wt. %.

6. The welding feedstock of claim 1, comprising:
Fe: about 7.2 to about 10.8 wt. %;
Mn or Ni: about 4 to about 6 wt. %; and
Si: about 3.2 to about 4.8 wt. %.

7. The welding feedstock of claim 6, comprising:
Fe: about 8.1 to about 9.9 wt. %;
Mn or Ni: about 4.5 to about 5.5 wt. %; and
Si: about 3.6 to about 4.4 wt. %.

8. The welding feedstock of claim 1, comprising:
Fe: about 12. 8 to about 19.2 wt. %;
Mn or Ni: about 11.2 to about 16.8 wt. %;
Si: about 3.2 to about 4.8 wt. %; and
B: about 0.8 to about 1.2 wt. %.

9. The welding feedstock of claim 8, comprising:
Fe: about 14.4 to about 17.6 wt. %;
Mn or Ni: about 12.6 to about 15.4 wt. %;
Si: about 3.6 to about 4.4 wt. %; and
B: about 0.9 to about 1.1 wt. %.

10. The welding feedstock of claim 1, comprising:
Fe: about 11.2 to about 16.8 wt. %;
Mn or Ni: about 10.8 to about 15.6 wt. %; and
Si: about 4.8 to about 7.2 wt. %.

11. The welding feedstock of claim 10, further comprising:
Fe: about 12.6 to about 15.4 wt. %;
Mn or Ni: about 12.6 to about 14.3 wt. %; and
Si: about 5.4 to 6.6 wt. %.

12. The welding feedstock of any one of claims 1-11, wherein the feedstock is configured to form a Cu-based matrix comprising at least about 85 wt. % Cu.

13. The welding feedstock of any one of claims 1-12, wherein the welding feedstock is substantially free of nickel.

14. The welding feedstock of any one of claims 1-13, wherein the welding feedstock is a powder.

15. The welding feedstock of any one of claims 1-14, wherein the welding feedstock is configured to be applied as a layer via a laser.

16. The welding feedstock of any one of claims 1-15, wherein the feedstock is characterized by having a total hard phase fraction of silicides, carbides and borides at 1100K of at least 10 mole %, wherein the feedstock is configured to form two immiscible liquid phases during solidification and is configured to form a microstructure containing hard phases within a Cu-based matrix, and wherein a silicide phase formation temperature of the feedstock is between 1000K and 1600K.

17. The welding feedstock of claim 16, wherein the feedstock is characterized by having a total hard phase fraction of silicides, carbides and borides at 1100K of at least 15 mole %, and wherein a silicide phase formation temperature of the alloy is between 1000K and 1400K.

18. The welding feedstock of claim 17, wherein the feedstock is characterized by having a total hard phase fraction of silicides, carbides and borides at 1100K of at least 20 mole %, and wherein a silicide phase formation temperature of the feedstock is between 1000K and 1300K.

19. A hardfacing layer formed from the welding feedstock of any one of claims 1-18.

20. The hardfacing layer of claim 19, wherein the hardfacing layer comprises a Cu-based matrix comprising at least 85 wt. % Cu.

21. The hardfacing layer of any one of claim 19, wherein the hardfacing layer comprises a Cu-based matrix comprising at least 90 wt. % Cu.

22. The hardfacing layer of claim 19, wherein the hardfacing layer comprises a Cu-based matrix comprising at least 95 wt. % Cu.

23. The hardfacing layer of any one of claims 19-22, wherein the hardfacing layer comprises a total volume fraction of silicides, carbides and borides of at least 10 volume %, wherein the hardness of the silicide phase is equal to or less than 1200 HV, and wherein the hardfacing layer contains a total of about 2 wt. % or less of Co, Mn, Mo, Ta, V, and W.

24. The hardfacing layer of any one of claims 19-22, wherein the hardfacing layer comprises a total volume fraction of silicides, carbides and borides of at least 15 volume %, wherein the hardness of the silicide phase is equal to or less than 100 HV, and wherein the hardfacing layer contains a total of about 2 wt. % or less of Co, Mn, Mo, Ta, V, and W.

25. The hardfacing layer of any one of claims 19-22, wherein the hardfacing layer comprises a total volume fraction of silicides, carbides and borides of at least 20 volume %, wherein the hardness of the silicide phase is equal to or less than 800 HV, and wherein the hardfacing layer contains a total of about 2 wt. % or less of Co, Mn, Mo, Ta, V, and W.

26. The hardfacing layer of any one of claims 19-25, wherein the hardfacing layer comprises an ASTM G77 volume loss of at most 1.0 mm³, 2 cracks or fewer per square inch when forming a hardfacing layer, and wherein the hardfacing layer contains a total of about 2 wt. % or less of Co, Mn, Mo, Ta, V and W.

27. The hardfacing layer of any one of claims 19-25, wherein the hardfacing layer comprises an ASTM G77 volume loss of at most 0.9 mm³, 1 cracks or fewer per square inch when forming a hardfacing layer, and wherein the hardfacing layer contains a total of about 2 wt. % or less of Co, Mn, Mo, Ta, V and W.

28. The hardfacing layer of any one of claims 19-25, wherein the hardfacing layer comprises an ASTM G77 volume loss of at most 0.8 mm³, 0 cracks or fewer per square inch when forming a hardfacing layer, and wherein the hardfacing layer contains a total of about 2 wt. % or less of Co, Mn, Mo, Ta, V and W.

29. A method of applying a hardfacing layer, the method comprising laser welding the welding feedstock of any one of claims 1-18, wherein the welding feedstock is a powder.

30. An article of manufacture comprising an alloy forming or configured to form a material comprising:
a Cu-based matrix comprising at least 85 weight % Cu; and
a total hard phase fraction of silicides, carbides and borides at 1100K of at least 10 mole %;
wherein the alloy is configured to form two immiscible liquid phases during solidification and forms a microstructure containing hard phases within the Cu-based matrix;
wherein a silicide phase formation temperature of the alloy is between 1000K and 1600K; and
wherein the alloy contains a total of about 2 wt. % or less of Co, Mn, Mo, Ta, V, and W.

31. The article of manufacture of claim 30, comprising an alloy forming or configured to form a material comprising:
a Cu-based matrix comprising at least 90 weight % Cu; and
a total hard phase fraction of silicides, carbides and borides at 1100K of at least 15 mole %;
wherein a silicide phase formation temperature of the alloy is between 1000K and 1400K.

32. The article of manufacture of claim 30, comprising an alloy forming or configured to form a material comprising:
a Cu-based matrix comprising at least 95 weight % Cu; and
a total hard phase fraction of silicides, carbides and borides at 1100K of at least 20 mole %;
wherein the silicide phase formation temperature of the alloy is between 1000K and 1300K.

33. The article of manufacture of any one of claims 30-32, wherein the alloy forms or is configured to form a material comprising Cu and in weight percent:
C: about 0.1 to about 1.0;
Cr: about 5 to about 20;
Fe: about 1 to about 15;
Nb: about 0 to about 5;
Ni: about 5 to about 20;
Si: about 2 to about 5; and
Ti: about 0 to about 5.

34. The article of manufacture of any one of claims 30-32, wherein the alloy is in the form of a feedstock comprising Cu and in weight %:
C: 0.1, Cr: 6.5, Fe: 9, Nb: 1, Ni: 17, Si: 3;
C: 0.1, Cr: 7, Fe: 9, Nb: 1, Ni: 5, Si: 4;
C: 0.6, Cr: 5, Fe: 5, Nb: 5, Ni: 5, Si: 4;
C: 0.1 Fe: 18, Nb: 1. Ni:7, Si:6; or
C: 0.1 Fe: 14, Nb: 1. Ni:13, Si:6.

35. A hardfacing layer formed from the article of any one of claims 30-34.

36. The hardfacing layer of claim 35, wherein the article is applied onto a cylinder head for an internal combustion engine to form the hardfacing layer.

37. The article of manufacture of any one of claims 30-34, wherein the alloy is in the form of a powder.

38. The article of manufacture of any one of claims 30-34, wherein the alloy is in the form of a metal cored wire.

39. An article of manufacture comprising an alloy forming or configured to form a material comprising:
a Cu-based matrix comprising at least 85 weight % Cu; and
a total volume fraction of silicides, carbides and borides of at least 10 volume %;
wherein the hardness of the silicide phase is equal to or less than 1200 HV; and
wherein the alloy contains a total of about 2 wt. % or less of Co, Mn, Mo, Ta, V, and W.

40. The article of manufacture of claim 39, comprising an alloy forming or configured to form a material comprising:
a Cu-based matrix comprising at least 90 weight % Cu; and
a total hard phase fraction of silicides, carbides and borides of at least 15 volume % comprising a silicide phase and a carbide phase;
wherein the hardness of the silicide phase is equal to or less than 1000 HV.

41. The article of manufacture of claim 39, comprising of an alloy forming or configured to form a material comprising:
a Cu-based matrix comprising at least 95 weight % Cu; and
a total hard phase fraction of silicides, carbides and borides of at least 20 volume %;
wherein the hardness of the silicide phase is equal to or less than 800 HV.

42. The article of manufacture of any one of claims 39-41, wherein the alloy forms or is configured to form a material comprising Cu and in weight percent:
C: about 0.1 to about 1.0;
Cr: about 5 to about 20;
Fe: about 1 to about 15;
Nb: about 0 to about 5;
Ni: about 5 to about 20;
Si: about 2 to about 5; and
Ti: about 0 to about 5.

43. The article of manufacture of any one of claims 39-41, wherein the alloy is in the form of a feedstock comprising Cu and in weight %:
C: 0.1, Cr: 6.5, Fe: 9, Nb: 1, Ni: 17, Si: 3;
C: 0.1, Cr: 7, Fe: 9, Nb: 1, Ni: 5, Si: 4;
C: 0.6, Cr: 5, Fe: 5, Nb: 5, Ni: 5, Si: 4;
C: 0.1 Fe: 18, Nb: 1. Ni:7, Si:6; or
C: 0.1 Fe: 14, Nb: 1. Ni:13, Si:6.

44. A hardfacing layer formed from the article of any one of claims 39-43.

45. The hardfacing layer of claim 44, wherein the article is applied onto a cylinder head for an internal combustion engine to form the hardfacing layer.

46. The article of manufacture of any one of claims 39-43, wherein the alloy is in the form of a powder.

47. The article of manufacture of any one of claims 39-43, wherein the alloy is in the form of a metal cored wire.

48. An article of manufacture comprising an alloy forming or configured to form a material having:
an ASTM G77 volume loss of at most 1.0 mm³;
2 cracks or fewer per square inch when forming a hardfacing layer; and
wherein the alloy contains a total of about 2 wt. % or less of Co, Mn, Mo, Ta, V and W.

49. The article of manufacture of claim 48, comprising an alloy forming or configured to form a material comprising:
an ASTM G77 volume loss of 0.9 mm³ or less; and
1 crack or fewer per square inch when forming a hardfacing layer.

50. The article of manufacture of claim 48, comprising an alloy forming or configured to forma a material comprising:
an ASTM G77 volume loss of 0.8 mm³ or less; and
0 cracks per square inch when forming a hardfacing layer.

51. The article of manufacture of any one of claims 48-50, further comprising Cu and in weight percent:
C: about 0.1 to about 1.0;
Cr: about 5 to about 20;
Fe: about 1 to about 15;
Nb: about 0 to about 5;
Ni: about 5 to about 20;
Si: about 2 to about 5; and
Ti: about 0 to about 5.

52. The article of manufacture of any one of claims 48-50, wherein the alloy is in the form of a feedstock comprising Cu and in weight %:
C: 0.1, Cr: 6.5, Fe: 9, Nb: 1, Ni: 17, Si: 3;
C: 0.1, Cr: 7, Fe: 9, Nb: 1, Ni: 5, Si: 4;
C: 0.6, Cr: 5, Fe: 5, Nb: 5, Ni: 5, Si: 4;
C: 0.1 Fe: 18, Nb: 1. Ni:7, Si:6; or
C: 0.1 Fe: 14, Nb: 1. Ni:13, Si:6.

53. A hardfacing layer formed from the article of any one of claims 48-52.

54. The hardfacing layer of claim 53, wherein the article is applied onto a cylinder head for an internal combustion engine to form the hardfacing layer.

55. The article of manufacture of any one of claims 48-52, wherein the alloy is in the form of a powder.

56. The article of manufacture of any one of claims 48-52, wherein the alloy is in the form of a metal cored wire.

57. A method of laser welding comprising cladding an aluminum substrate using a metal cored copper-based wire.

58. The method of claim 57, wherein a short wavelength laser of blue or green light is utilized.

59. The method of any one of claims 57-58, wherein automotive components are clad.

60. The method of any one of claims 57-58, wherein engine block valves or cylinder heads are clad.

61. The method of any one of claims 57-60, wherein the wire comprises Cu and in weight %:
C: about 0.1 to about 1.0;
Cr: about 0 to about 20;
Fe: about 1 to about 25;
Nb: about 0 to about 5;
Ni: about 5 to about 25;
Si: about 2 to about 5; and
Ti: about 0 to about 5.
